(19) United States
(12) Patent Application Publication
(10) Pub. No.: US 2008/0180415 A1
(43) Pub. Date: Jul. 31, 2008

(54) DRIVING SYSTEM OF A DISPLAY PANEL

(75) Inventors: Jiunn-Yau HUANG, Sinshih Township (TW); Chih-Chung TSAI, Sinshih Township (TW); Yi-Lin SU, Sinshih Township (TW)

Correspondence Address: LOWE HAUPTMAN HAM & BERNER, LLP, 1700 DIAGONAL ROAD, SUITE 300, ALEXANDRIA, VA, 22314, US

(73) Assignee: HIMAX TECHNOLOGIES LIMITED, Sinshih Township (TW)

(21) Appl. No.: 11/668,674

(22) Filed: Jan. 30, 2007

(51) Int. Cl. G06F 3/038

(52) U.S. Cl. 345/204

(57) ABSTRACT

A driving system of a display panel has a code identification device and several source drivers. The code identification device provides driving-capacity information of the display panel. The source drivers drive the display panel according to the driving-capacity information.

### BACKGROUND

1. Field of Invention

The present invention relates to a driving system of a display panel, and more particularly relates to a driving system with different driving capabilities.

2. Description of Related Art

Flat panel displays (FPD) have become very popular due to their advantages of high image quality, compact size, light weight, low driving voltage and low power consumption. They are especially suitable for portable TVs, portable multimedia players, mobile phones, PDAs (personal digital assistants), portable game consoles, and many other kinds of portable consumer electronics including a display.

For the purpose of customization, there are many kinds of FPDs with different types, sizes, resolutions or power consumptions, which have different requirements on the ability of the driving system. Therefore, different driving systems each having specific driving-capability for one kind of FPD must be designed, which results in increase of cost.

### SUMMARY

It is therefore the present invention provides a driving system capable of providing different driving capabilities of different display panels.

According to one embodiment of the present invention, the driving system of a display panel has a code identification device and several source drivers. The code identification device provides driving-capacity information of the display panel. The source drivers drive the display panel according to the driving-capacity information.

According to another embodiment of the present invention, the driving system of a display panel divided into several regions has several code identification devices and several source drivers. The code identification devices correspondingly provide driving-capacity information of each region. The source drivers correspondingly drive each region of the display panel according to the driving-capacity information of each region.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A is a driving system according to one embodiment of the present invention;

FIG. 1B is a code identification device of the driving system according to one embodiment of the present invention;

FIG. 1C is a driving system according to another embodiment of the present invention;

FIG. 1D is driving system according to another embodiment of the present invention; and

FIG. 2 is a driving system according to another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

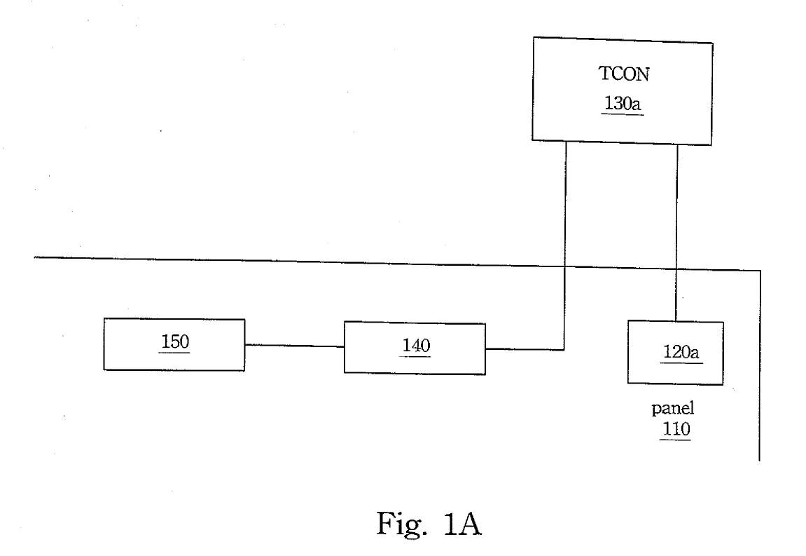

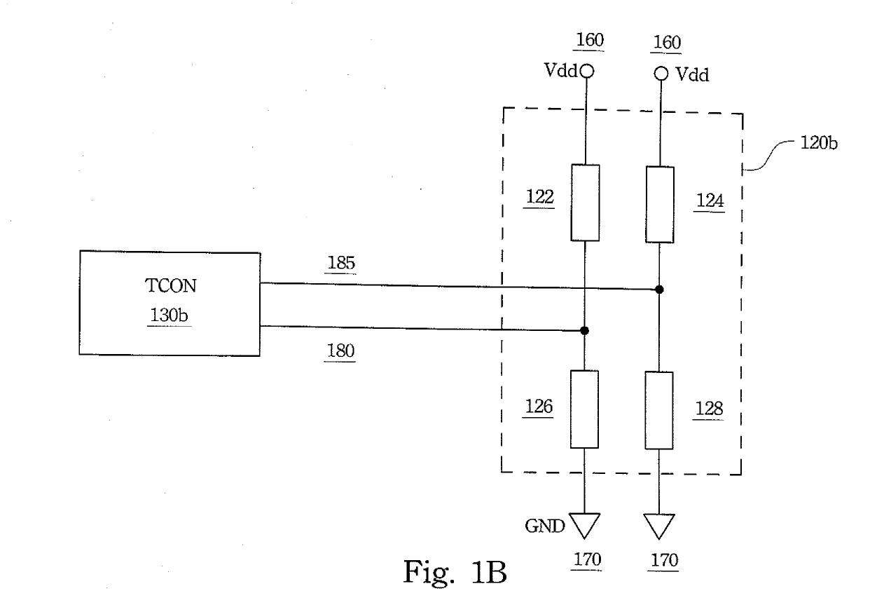

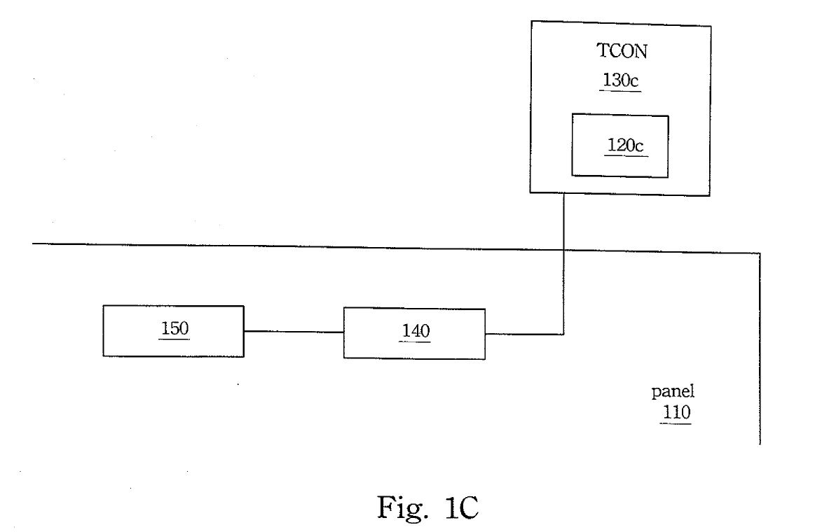

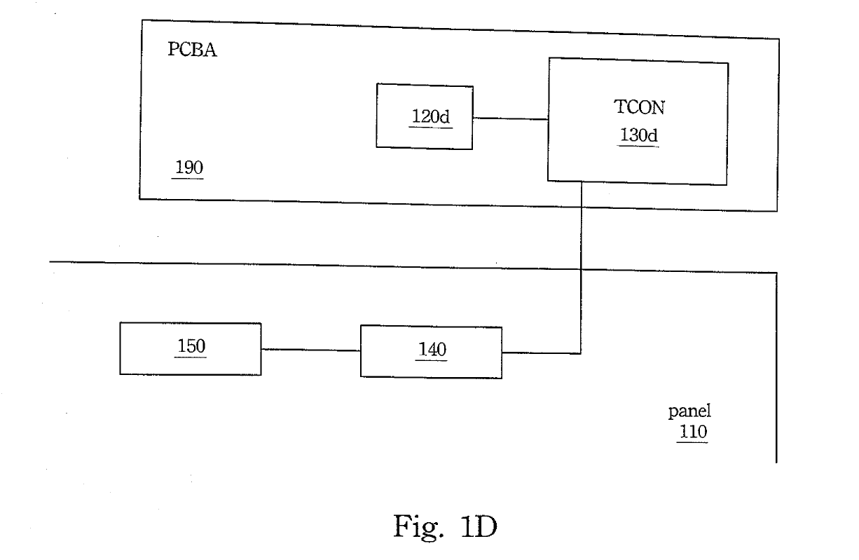

FIG. 1A is a driving system according to one embodiment of the present invention. The driving system of a display panel 110 has a code identification device 120a and several source drivers. The number of source drivers of the driving system depends on the types, sizes, resolutions or power consumption of the panel 110. Only two source drivers 140 and 150 are illustrated for example. The code identification device 120a is arranged to provide driving-capacity information to the display panel 110. The source drivers 140 and 150 are arranged to drive the display panel 110 according to the driving-capacity information.

The driving system further has a timing controller 130a transmitting the driving-capacity information from the code identification device 120a to the source drivers 140 and 150. Therefore, the drivers 140 and 150 can drive the panel 110 according to the driving-capacity information.

FIG. 1B is a code identification device of the driving system according to one embodiment of the present invention. The code identification device 120b has several resistors to provide the driving-capacity information. These resistors are coupled to the high voltage end (Vdd) 160 or the low voltage end (GND) 170. Different combinations of connections between the resistors and the voltage ends 160 or 170 could be adopted for different kinds of driving-capacity information.

In this embodiment, four resistors 122, 124, 126 and 128 are included. The resistors 122 and 124 are coupled to the high voltage end 160, and the resistors 126 and 128 are coupled to the low voltage end 170. The voltage generated by the combination of resistors 124 and 128 is transferred through the line 180 to the timing controller 130b; the voltage generated by the combination of resistors 122 and 126 is transferred through the line 185 to the timing controller 130b. For example, when the resistor 122 is 0[Ω], and the resistor 126 is not 0[Ω] (such as 5 or 10[Ω]), the signal ‘1’ (high voltage) is transferred through the line 180 to the timing controller 130b. Meanwhile, when the resistor 128 is 0[Ω], and the resistor 124 is not 0[Ω], the signal ‘0’ (low voltage) is transferred through the line 185 to the timing controller 130b. Thereby, the timing controller 130b receives the driving-capacity information represented by (1,0) generated by the combination. 4 combinations (0,0), (1,0), (0,1) and (1,1) can be derived by selecting different values of the four resistors 122, 124, 126 and 128 and each combination represents one type of driving-capacity information. The number of resistors could be increased for more driving-capacity information.

The code identification device can be located in the timing controller, the display panel, a print circuit board assembly, or a source driver according to its type or other design requirements.

FIG. 1C is a driving system according to another embodiment of the present invention, wherein the code identification device 120c is located in the timing controller 130c.

FIG. 1D is driving system according to another embodiment of the present invention, wherein the code identification device 120d is located on the print circuit board assembly (PCBA) 190, and the timing controller 130d cooperates with the code identification device 120d to drive the panel 110.

Moreover, the code identification device 120 can be implemented by a static random-access memory or an electrically erasable programmable read-only memory which stores the driving-capacity information in an index table. The index table can be a look up table. The following table shows an example.

| | Resolution 1 | Resolution 2 | Resolution 3 | Resolution 4 |
|---|---|---|---|---|
| Size 1 | Driving | | | |
| | Capacity (11) | | | |
| Size 2 | Driving | Driving | Driving | |
| | Capacity (12) | Capacity (22) | Capacity (32) | |
| Size 3 | Driving | | | Driving |
| | Capacity (13) | | | Capacity |
| | | | | (43) |

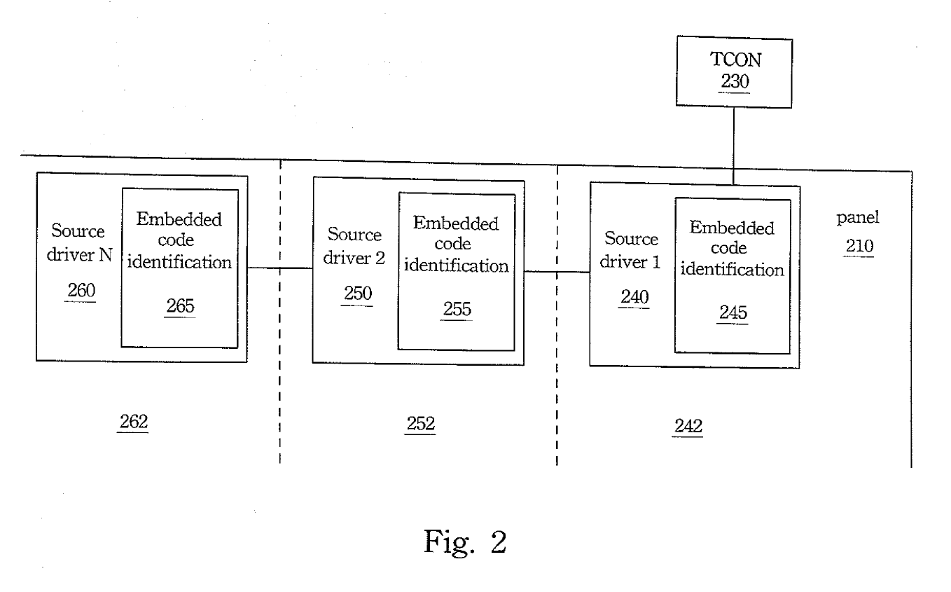

FIG. 2 is a driving system according to another embodiment of the present invention. The difference between the systems of FIG. 1A and FIG. 2 is that the display panel 210 of FIG. 2 is divided into 3 regions. The driving system of the display panel 210 has the code identification devices 245, 255, 265, and the source drivers 240, 250, 260. The code identification devices 245, 255 and 265 correspondingly provide driving-capacity information of the regions 242, 252 and 262. The source drivers 240, 250 and 260 correspondingly drive each region of the display panel according to the driving-capacity information of each region. For example, the code identification devices 245 provides the driving-capacity information of the regions 242, and the source drivers 240 drives the region 242 of the display panel 210 according to the driving-capacity information of the region 242.

The driving system further has a timing controller 230 transmitting the driving-capacity information from each code identification device to a corresponding one of the source drivers 240, 250 and 260. The code identification devices are located on the display panel 210. The code identification devices could be commonly located on the display panel 210, or separately in each source driver of each region.

Similarly to the system of the FIG. 1A, each of the code identification devices 245, 255 and 265 has several resistors to provide the driving-capacity information of one of the regions 242, 252 and 262.

Moreover, the code identification devices 245, 255 and 265 can be implemented by a static random-access memory or an electrically erasable programmable read-only memory which stores the driving-capacity information in an index table. The index table can be a look up table.

The code identification devices 245, 255 and 265 can be located in the timing controller 230, the display panel 210, a printed circuit board assembly (not shown), or the source drivers 240, 250, and 260 according to its type or other design requirements.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving system of a display panel, comprising:
a code identification device providing driving-capacity information of the display panel; and
a plurality of source drivers driving the display panel according to the driving-capacity information.

2. The driving system as claimed in claim 1, further comprising a timing controller to transmit the driving-capacity information from the code identification device to the source drivers.

3. The driving system as claimed in claim 1, wherein the code identification device comprises a plurality of resistors to provide the driving-capacity information.

4. The driving system as claimed in claim 1, wherein the code identification device is a static random-access memory or an electrically erasable programmable read-only memory storing the driving-capacity information in an index table.

5. The driving system as claimed in claim 1, wherein the code identification device is configured in the timing controller.

6. The driving system as claimed in claim 1, wherein the code identification device is configured on the display panel.

7. The driving system as claimed in claim 1, wherein the code identification device is configured on a printed circuit board assembly.

8. The driving system as claimed in claim 1, wherein the code identification device is configured in one of the source drivers.

9. A driving system of a display panel that is divided into a plurality of regions, the driving system comprising:
a plurality of code identification devices correspondingly providing driving-capacity information of each region; and
a plurality of source drivers correspondingly driving each region of the display panel according to the driving-capacity information of each region.

10. The driving system as claimed in claim 9, further comprising a timing controller to correspondingly transmit the driving-capacity information from each code identification device to each source driver.

11. The driving system as claimed in claim 9, wherein the code identification devices respectively comprise a plurality of resistors to provide the driving-capacity information.

12. The driving system as claimed in claim 9, wherein the code identification devices are implemented as a static random-access memory or an electrically erasable programmable read-only memory storing the driving-capacity information in an index table.

13. The driving system as claimed in claim 9, wherein the code identification devices are configured in the timing controller.

14. The driving system as claimed in claim 9, wherein the code identification devices are configured on the display panel.

15. The driving system as claimed in claim 9, wherein the code identification devices are configured on a printed circuit board assembly.

16. The driving system as claimed in claim 9, wherein the code identification devices are correspondingly configured in each source driver.
